(19) United States
(12) Patent Application Publication
(10) Pub. No.: US 2011/0268371 A1
(43) Pub. Date: Nov. 3, 2011

(54) METHOD FOR CONFIGURATIONALLY HEAT SOLDERING PLASTIC PACKAGING AND TAMPER EVIDENT PLASTIC PACKAGINGS

(76) Inventor: Boaz KRISTAL, Zichron Yaakov (IL)

(21) Appl. No.: 13/108,276

(22) Filed: May 16, 2011

Related U.S. Application Data
(63) Continuation-in-part of application No. PCT/IL2009/001072, filed on Nov. 15, 2009.
(60) Provisional application No. 61/193,302, filed on Nov. 14, 2008.
(60) Provisional application No. 61/452,780, filed on Mar. 15, 2011.

(51) Int. Cl. B65D 33/18; B32B 38/00; B32B 37/06; B32B 37/10; B32B 37/02; B32B 37/04

(52) U.S. Cl. 383/5; 156/245; 156/583.1

(57) ABSTRACT

A system and method for imprinting distinct patterns along a seam by which two or more layered plastic sheets are mutually attached to each other is provided. The disclosed method comprises (i) heating selected contours located across a surface of the layered plastic to a predefined temperature, and (ii) forcing a molding head against the heated surface, wherein the molding member has a face from which a plurality of pressing faces extend towards a common direction, the footprint of which features the desired pattern. A soldering head of the disclosed system has at least one molding member having a plurality of fingers. The footprints of the fingers are geometrically shaped in accordance with the pattern to be imprinted along the seam. Some of the fingers may have sharpened tips. A soldering head optionally comprises a pressing member for pressing against peripheries of the footprints of the fingers located across the surface of the layered plastic. A soldering head may also comprise a mold that has recesses that fit in with the fingers of the respective molding member. The temperatures of both the molding member and of the mold are independently controllable. Such soldering head provides for embossing distinct three dimensional patterns across the soldered layered plastic sheets. Tamper evident packaging such as envelopes are further provided.

### FIELD OF THE INVENTION

The present invention relates in general to plastic packaging such as bags and in particular to configurationally heat soldering plastic sheets and manufacturing of tamper evident packing and tamper evident envelopes.

### BACKGROUND OF THE INVENTION

Tamper evident envelopes made of plastic resins such as polyethylene are common in the marketplace. Normally the open edges of one folded foil, or two sheets of plastic foil laid one on top of the other are mutually attached by thermal soldering. A continuous line is typically printed along the seams providing for tamper evidence. Normally soldering is applied by contact heating and concomitantly pressing the two layers of plastic one against the other. Reference is now made to FIGS. 1-5 in which cross sectional views of a number of common soldering stations are respectively shown. Such stations provide for heat soldering the edges of the envelopes. A soldering station especially suited for soldering soft plastic layers, such as thin sheets made of polyethylene, as well as sheets of plastic foam is presented in FIG. 1. Electrically heated wire 10 activated by short pulses of electrical current heats two layers of plastic to be mutually attached when soldering heads 12 are pressed against each other while trapping the layered plastic sheets in between them. The heat capacity of soldering heads 12, which is relatively high provides for cooling off the seam by the end of each heating pulse. However the time required for heating up to a temperature suitable for soldering along each and every heating pulse provides for a relatively low soldering rate which is only of a few soldering cycles per minute.

Alternative methods in which the soldering heads are kept at an almost constant temperature provide for enhanced soldering rates is demonstrated by soldering station 14 that is shown In FIG. 2. Soldering heads 16 are heated to the suitable temperature by a constant electric current conducted through embedded electrical heaters 18. The sheets to be mutually attached are simultaneously moved laterally to the soldering heads along a track passing through station 14, not shown. In another station disposed next to station 14, not shown, similar heads through which coolant streams, are pressed against the relatively wide seams to cool them off. The mutually attached sheets are further cut off along a line disposed within the region of a seam such that individual bags are separated in the following station. Such method is especially suited to laminated sheets having an inner layer, which is practically melted by such heating. A more popular method especially suited to attaching thin plastic sheets is demonstrated by the soldering station shown in FIG. 3. Soldering heads 20 retained at a suitable temperature by means of heating elements 21 are simultaneously pressed for a predefined period of time against the two layers of thin plastic sheets whilst being supported by base 22. Both layers are simultaneously cut by means of blade 24. The seams cool off by means of radiation and heat conduction to the ambient atmosphere. Another method especially suited for soldering soft and thin plastic sheets is demonstrated by the soldering station shown in FIG. 4. Cutting and soldering is applied by repeatedly pressing layers 28 while being sandwiched between soldering head 30 and cylinder 32. Soldering head 30 has tipped sharpened end 31. The hot blade formed by tip 31 practically melts both layers. Cylinder 32 rotates between successive soldering cycles, such that heating is applied each time when tip 31 presses against a different location across the surface of cylinder 32. The seams are contact cooled by cylinder 32 when the soldering head is pulled off. This method is commonly applied in manufacturing thin bags. Such soldering station provides for production rates of a few hundred soldering cycles per minute. However it is not suitable for manufacturing bags made of relatively thick sheets, plastic foam or bubbled sheets. Another method providing a relatively high rate of soldering cycles is demonstrated by the soldering station shown in FIG. 5. Both plastic sheets 38 are simultaneously pressed between pressing arm 40 and soldering head 42, such that layers 38 are forced by sharpened tip 44 against heating element 46. At this point a heating pulse is applied. The sharpened tip provides for cutting both sheets concomitantly with forming of the seams at both edges of the cut.

Tamper evident envelopes made of paper, which have a distinctive pattern embossed along their seams and a method for their manufacturing is disclosed in U.S. Pat. No. 5,727,686. The embossed pattern may include three dimensional alphanumerical characters as well as distinctive geometrical shapes. Therefore any attempt to cut the paper along a seam and reseal the envelope can be easily recognized by the user of the sealed envelope. The disclosed method of manufacturing such envelopes includes laying two sheets of paper one on top of the other, or suitably aligning two folds of a single sheet of paper for being adhered to each other at least along two sides of the envelope. Adhering is accomplished by means of suitable glue. The seams are pressed and heated while they are sandwiched between two molds for curing. One of these molds has a plurality of bulges extending off its face. These bulges have the respective geometrical shapes composing the pattern to be embossed along the seam. The other mold has recesses complying with the bulges of the first mold. These recesses are structured and arranged to enclose the respective bulges as well as the layered paper that fills in spacing that are present between the surfaces of a bulge and the surfaces of its matching recess.

The linear seams disposed along edges of common tamper evident envelopes made of plastic are generated according to common soldering methods such as described above. Linear continuous seams that characterize common tamper evident envelopes are vulnerable to breaching. A common sealed tamper evident envelope can be opened by cutting an edge and further resealing it by heat soldering, such that the additional seam will be hardly detected. However, distinctive patterns imprinted along seams that are heat soldered along the edges of tamper evident envelopes and/or packages that are made from plastic may provide for enhanced immunity against such breaching. Therefore tamper evident envelopes and packaging that are made of plastic sheets and have configurationally heat soldered seams are beneficial.

### BRIEF DESCRIPTION OF THE DRAWINGS

FIGS. 1-5 schematically present soldering stations in accordance with various known methods for heat soldering of plastic bags;

FIG. 6A is an isometric view of two members of a soldering head providing for configurationally heat soldering layered plastic sheets according to an embodiment of the present invention;

FIG. 6B is a sectional view of the heating member shown in FIG. 6A;

FIG. 6C is a sectional view of the pressing member shown in FIG. 6A;

FIG. 7A is a side view of a soldering head according to a preferred embodiment of the present invention;

FIG. 7B is an isometric view of the soldering head shown in FIG. 7A;

FIGS. 8A-8B schematically present segments of a soldering head providing for embossing a three dimensional pattern along a seam of a tamper evident envelope according to a preferred embodiment of the present invention;

FIG. 9A is an isometric view of a segment of an embossing head that can be used for manufacturing a tamper evident envelope according to another preferred embodiment of the present invention;

FIG. 9B schematically presents another segment of the embossing head shown in FIG. 9A;

FIGS. 10A-10B are two different isometric views of a molding member of a heat soldering head according to an embodiment of the present invention;

FIG. 10C is a segment of the molding member shown in FIGS. 10A-10B placed adjacent to its respective supporting surface;

FIG. 10D is a magnified detail of FIG. 10C;

FIGS. 11A-11C are side looking views of three tamper evident envelopes in accordance with three different preferred embodiments of the present invention;

FIGS. 11D-11E are side looking views of the same segment of a tamper evident envelope according to another preferred embodiment of the present invention;

FIG. 12 is a side looking view of a tamper evident envelope according to another preferred embodiment of the present invention;

FIG. 13A is a side looking view of a tamper evident envelope according to an embodiment of the present invention;

FIG. 13B is a sectional view of the envelope shown in FIG. 13A, along the line AA;

FIG. 14 is a side looking view of a molding member of a soldering head according to an embodiment of the present invention.

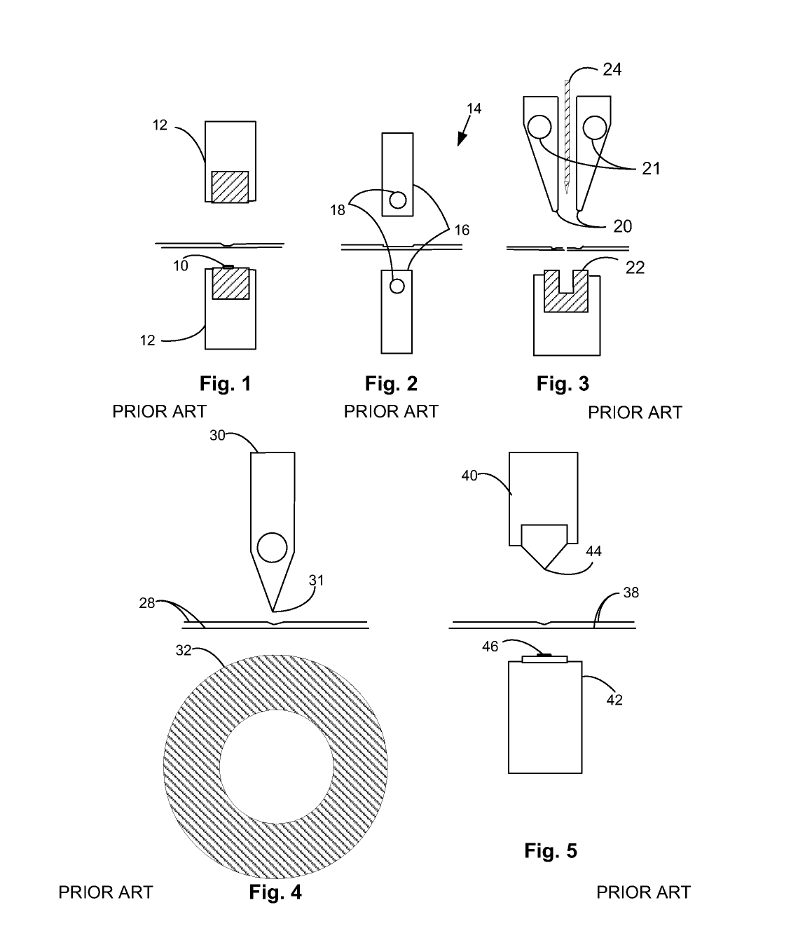

### DETAILED DESCRIPTION OF THE PRESENT INVENTION

In accordance with the present invention tamper evident packaging, bags, envelopes and/or packages, the seams of which are generated by configurational heat soldering of layered sheets of plastic, as well as heat soldering heads and a method for configurational heat soldering, are provided. Plastic packaging, such as bags and/or envelopes, manufactured by employing configurational heat soldering for mutually attaching separate sheets of plastic according to the method of the present invention has at least a segment of a seam in which one layer and a second layer of one or two plastic sheets are configurationally heat soldered to each other. Layered sheets of plastic according to the present invention include at least two segments of one folded sheet of plastic and/or at least two separated sheets of plastic. The segments of the folded sheet as well as the two separate sheets are disposed one across the other. Each such soldered seam has a distinctive pattern embossed on, and/or perforated through, one or both layers across a segment of significant length of the seam. In a case in which such bag is opened and resealed along one of these seams, the imprinted pattern is corrupted. Therefore an unauthorized opening of such seam becomes apparent to a user of the bag. The terms tamper evident envelope or bags refer hereinafter to tamper evident sealable packaging employing plastic sheets. There are two kinds of soldering heads employed in the various embodiments described below, each of which provides for configurational heat soldering according to the method of the present invention. Soldering heads of the first kind are especially suitable for soldering soft plastic sheets, such as bubble sheets or plastic foam. However, such soldering heads successfully cope with heat soldering nonwoven fabrics made of plastic resins such as Tyvek®. Soldering heads of the second kind provide for embossing any two and/or three-dimensional patterns along the seam of a plastic bag of the invention. Some of the soldering heads described below provide for applying three-dimensional embossed patterns onto various types of plastic sheets as further described infra. Soldering heads of the second kind are also referred hereinafter as embossing heads.

A soldering head providing for configurational heat soldering normally comprises a molding member and a heating member. Soldering heads of the first kind optionally further include a pressing member. The heating members provide for heating the layered plastic at predefined heating rates such that their respective surfaces fuse to be mutually heat soldered when the layers are pressed against each other and cooled off. The molding members provide for pressing against the heated plastic layers concomitantly with imprinting and/or perforating a pattern across the seam. The pressing members provide for further compressing the layered plastic sheets and condensing them such that their width is decreased down to a desired level as well as for dissipating excessive heat conducted through the layered plastic to the margins of the contours imprinted across the seam. Wherever inward direction is referred to hereinbelow, it means the direction pointing from the edge towards the center of the layered plastic sheets.

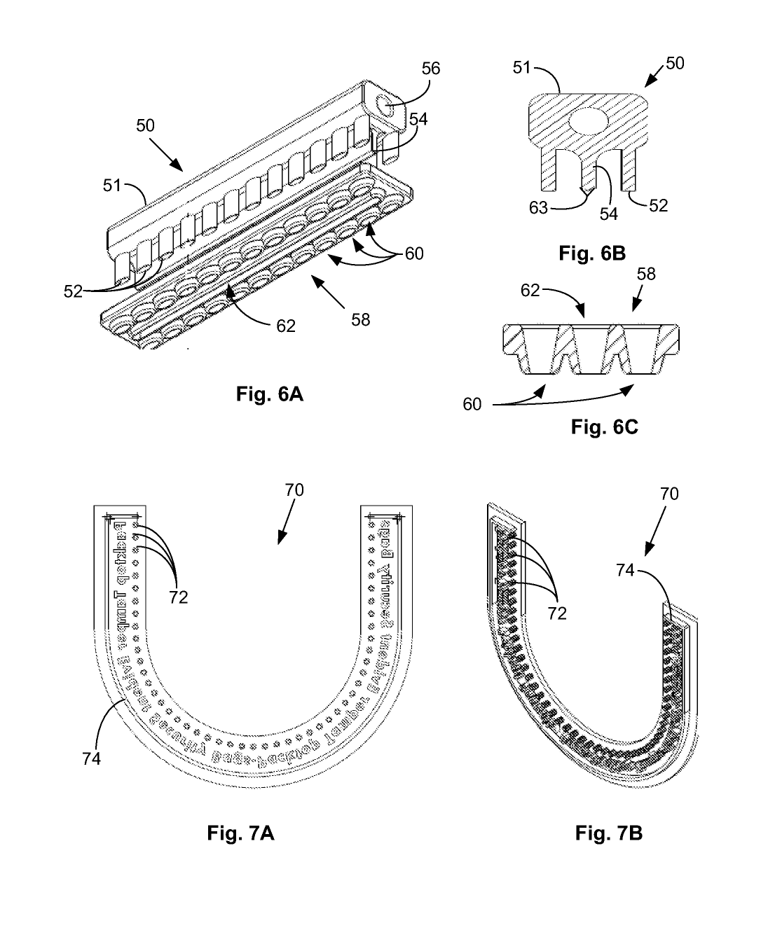

Reference is first made to FIGS. 6A-7B in which two soldering heads of the first kind are respectively shown. In FIG. 6A a segment of an assembly scheme of a soldering head is shown. Molding member 50 consists of body 51 from one side of which two rows having a plurality of fingers 52 separated by elongated prism 54 extend off the surface of body 51 towards a common direction. Electric heater 56 is embedded in an elongated cavity coaxially disposed within body 51. Molding member 50 provides for contact heating a surface when the faces of its fingers and prism are pressed against it. The faces of the fingers as well as the faces of the prism are referred hereinafter as pressing faces. The segment of the surface of this molding member from which the fingers extend does not engage the layered plastic at any time. Molding member 50 serves also as the heating member of the soldering head considered as well. The pressing faces (of fingers 52 and/or prism 54) may have any geometrical shape, such as pointed, circular, oval, curvilinear, or polygonal such that their footprints across the heated plastic layer have a distinct pattern. Similarly, fingers whose pressing faces are shaped as alphanumeric characters, symbols, or graphical patterns or closed geometrical shapes such as star, polygon, circle, or ellipse, are in accordance with the present invention. Optionally, curvilinear elongated bulges or a series of evenly spaced fingers aligned along a linear or curvilinear line may be substituted for prism 54. Such series of bulges or fingers are also referred hereinafter as a prism. The outermost surface of such bulges serves as the pressing face of such fingers. The rows of fingers need not be linear, but can be according to the present invention curved or wiggled at different curvature angles. One or more rows can be disposed according to the present invention at both sides of prism 54. Optionally, one or more prisms with or without being interleaved with rows of fingers extend off the face of body 51.

Pressing member 58 consists of a flat body having arrays of apertures 60 that conform to the fingers and prisms of molding member 50. All these apertures are skirted with sharpened bulges protruding towards the same direction. Such sharpened bulges provide for enhancing the pressure exerted onto the layered plastic at the margins of the contours to be heated by means of the pressing faces of molding member 50. The layered plastic is sandwiched between the pressing faces of the molding members as well as the bulges that skirt the apertures of the pressing member and a supporting surface, not shown. The supporting surface provides for cooling the heated regions of the layered plastic as well as for exerting resisting forces against the pressed plastic thereby forcing the various sheets to stick together. In a case in which the fingers and prisms of the molding member are made of a rigid material, such as stainless steel, a relatively soft surface such as made of silicone or silicone rubber supports the opposite side of the layered plastic. However, in cases in which the fingers and prisms are made of a soft material the supporting surface is made of a rigid material such that a distinct pattern is imprinted onto the sandwiched plastic.

In FIGS. 6B and 6C, sectional views of members 50 and 58 shown in FIG. 6A are respectively shown. The same parts shown in all of these three figures are indicated by the same numerals. Sharpened tip 63 of prism 54 provides for cutting a sheet or layered sheets of plastic when heated and forced towards the topmost layer. The pressing member is forced against the layers to be configurationally heat soldered at a predefined force that is selected in accordance with the widths and the materials from which the plastic sheets are made. The level by which the pressing member presses the layered sheets as well as the time along which pressing is applied are crucial to the quality and distinctness of the patterns to be imprinted across a seam. Biasing springs, not shown, optionally connect pressing member 58 to molding member 50. Therefore, when the molding member is moved towards the layered plastic, pressing member 58 first presses the sandwiched plastic before the heated fingers 52 touch its surface. Such enhanced pressing at the margins of the contours targeted for heating provides for retaining the tension applied onto the segment of the heated plastic at a constant level and condensing the layered plastic such that the width of the sandwiched plastic reduces to a desired level. Similarly, when the molding member is moved away from the layered plastic, the pressing member continues to press it for better cooling the generated seams and avoiding shrinkage of the cooling segments.

The footprints of the pressing faces of a molding member are referred to hereinafter as features of the pattern. These features include and are not limited, according to the present invention, to graphical and typographical symbols and/or continuous and/or discontinuous, dashed or dotted lines, which are linear and/or curvilinear. The features are embossed on, and/or perforated through, the layered plastic. The patterns imprinted along a seam by means of the soldering heads described above are characterized by more than one continuous tier of soldered segments, each of which is successively aligned in a direction pointing inwards off a respective edge of the bag. Therefore, even an insertion of a thin object, such as a fiber-optic, is involved with cutting through more than one such segments of heat soldered plastic.

In FIGS. 7A and 7B, side and isometric views of a molding member of a soldering head of the first kind according to a preferred embodiment of the present invention are respectively shown. The same parts shown in both figures are indicated by the same numerals. This soldering head, that is shaped as a horseshoe, consists of molding member 70 and a matching pressing member, not shown, which is provided with a series of skirted apertures as described above. This pressing member is connected by biasing springs to molding member 70, such that when this soldering head is moved towards the layered plastic, the bulges skirting the apertures of the pressing member first press against the layered plastic; a while later the pressing faces of the molding member touch the surface of the plastic. When the soldering head is moved in the opposite direction, first the pressing faces of the molding member are removed from the layered plastic, then, a while after, the tips of the pressing member are removed off the layered plastic. An inner curved prism, consisting of curved row of fingers 72, is inwardly disposed to continuous and curved prism 74. A soldering head in which any of these prisms is avoided is in accordance with the present invention. Another row of fingers, the faces of which are shaped as alphanumerical symbols, provide for printing in the space between the footprints of both prisms. The widths of the pressing faces of fingers 72, as well as the width of prism 74 are significantly smaller compared to the distance between any of the fingers 72 to prism 74. The footprints of both prisms provide for retaining the segment of the layered plastic sheets in between them stretched. Such stretching can be also retained in cases in which the pressing member is avoided. Therefore, any twisting and/or shrinking of this segment as a result of its being selectively and discontinuously heated and then cooled are significantly decreased. Optionally, heat printing is further applied on top of the soldered figures by means of a foil coated with heat-transferred color disposed between the bottom faces of these fingers and the surface to be pressed and further heated. Some of the fingers according to the present invention can be slightly longer than the other fingers and can have sharpened tips at their free ends, such that the soldered layers of plastic are perforated when they are pressed by the molding member. Any such perforation is skirted with a thin circular seam due to the contact with the heated finger. Such heat printing and/or perforation provide for enhancing the distinctness of a seam.

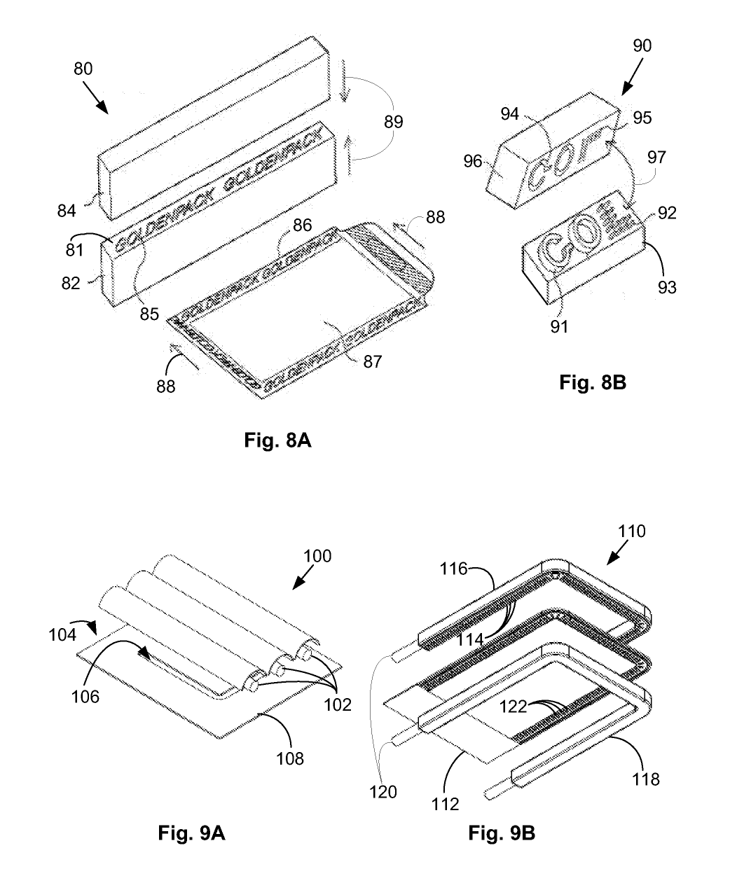

A pattern having three-dimensional features embossed on both layers of plastic along a seam provides a more distinct pattern, such that the opening and resealing of a seam can be more easily recognized. Reference is now made to FIGS. 8A-8B in which segments of embossing heads providing for a three-dimensional embossing of tamper evident envelopes in accordance with two different preferred embodiments of the present invention are respectively shown. In FIG. 8A embossing head 80 is shown. Embossing head 80 has molding members 82 and mold 84. Fingers, whose pressing faces are shaped like alphanumeric symbols, such as finger 85, extend towards the same direction from face 81. The lengths of these fingers exceed the thickness of the layered sheets of plastic. Therefore face 81 cannot engage the surface of the layered sheets while the molding member presses against them Recesses, not shown, all of which respectively conform to the fingers are disposed on the respective face of mold 84. This face of mold 84 does not engage the face 81 and therefore it cannot provide for pressing against the surface of the layered plastic sheets. However, the faces of the bottom of the recesses disposed along the face of the mold collectively serve as the supporting surface against which the pressing faces of the male molding member force the layered plastic for mutually attaching concomitantly with cooling them.

Alternatively, prisms and conformational grooves with or without fingers are disposed on the respective faces of molding members 82 and mold 84 respectively. The surface of a segment of the finger and the surface of the respective recess enclose a space that surrounds each pressing face of a finger into which the material of a segment of the heated layers of plastic is stretched and forced. The space existing between the fingers and the walls of the conformal recesses provides for structuring a three-dimensional geometrical shape that is filled with the material of the layered plastic. Embedded heaters and temperature control devices, not shown, provide for retaining the respective temperature of any of both molding members fixed at a respective predefined level. The temperature of the hot member, which is preferably molding member 82, is retained fixed within a predefined temperature interval below the melting point of the plastic resins utilized. The temperature of the other member is retained at a predefined temperature difference below. Namely, the heating member of this soldering head comprises both molding members 82 and 84. For soldering a seam such as seam 86, the respective edge of the bag such as tamper evident envelope 87, is moved along the direction of arrows 88 and placed between the jaws of soldering head 80. At this stage both molding members 82 and mold 84 are respectively forced to move in the direction of arrows 89 and press against the respective surfaces of the bag that is supported by the bottoms of the recesses of the female mold by a predefined force along a predefined time interval.

In FIG. 8B a segment of embossing head 90 in accordance with another preferred embodiment of a tamper evident envelope of the present invention is schematically shown. Curved fingers, such as finger 91, or slim and sharpened fingers, such as finger 92, protrude off the face of male molding member 93. Matching recesses such as recess 94 and 95 are respectively located at the face of female mold 96. The slim and sharpened fingers provide for perforating a pattern through the soldered plastic sheets. The pressing faces of the male molding member provide for embossing typographical features across the layered plastic sheets concomitantly with mutually soldering them. The layered sheets of plastic are not forced towards the face of the female mold since the surface of the layered sheets does not engage the face of the respective molding member. However all the faces of the bottoms of the recesses of the female mold that are disposed at a predefined distance beyond the face of mold 96 away from the layered plastic collectively form the supporting surface against which the layered plastic is pressed. (The female mold is shown artificially tilted in the directions shown by double arrow 97 to clarify the structure of both molding members.) Preferably the temperature of a male molding member is higher than the temperature of the female mold by a predefined temperature difference, such that the direction in which heat is conducted through the layered plastic complies with the direction of the movement of the plastic layers into the respective recesses of the female mold. The magnitude of the temperature gradient generated across the widths of the layered plastic sheets provide for fine tuning the quantity of heat to be absorbed by the layered plastic and avoiding excessive heating. The duration of the heating is the main factor providing for controlling the quantity of heat to be absorbed by the layered plastic.

The molding member of an embossing head can be located at both opposing sides of the layered plastic. This can be accomplished by successively combining a molding member with a mold. Alternatively speaking, a molding member of an embossing head of the invention may have a number of pressing faces as well as another number of recesses that conform to pressing faces extending off the other molding member that is located at the opposite side of the layered plastic. Namely, seams in which a segment of an embossed pattern protrudes off one face of the layered plastic and the successive segment of the pattern protrudes off the opposite face of the layered plastic can be heat soldered by such soldering heads. In such a case both molding members are heated to the same temperature. Cooling the heated plastic is effected in this case by the ambient atmosphere after the removal of the molding members off the sandwiched plastic. Soldering of the layered plastic and the associated embossing process are concomitantly effected with heating the layered plastic by means of the soldering head described above.

The heating and the pressing of the layered plastic need not be concomitantly effected according to the method of the present invention. The heating member and the molding member or members may be separated and incorporated in two different and independent units, as is hereby described with reference to FIGS. 9A-9B, which is now made. Heating member 100 has one or more heaters such as heaters 102 disposed in front of mask 104. Mask 104 has one or more apertures such as slot 106, which are cut through diaphragm 108. The layout and geometrical shape of these apertures conform to the contours of the seams to be imprinted on the surface of the plastic bag. Beam or beams of heat radiation having a geometrical shape conformal with the geometrical shapes of these apertures impinge upon the layered plastic, not shown, disposed in front of mask 104 at the side opposing to the side facing the heaters. The layered plastic is exposed to the heat radiation for a predefined time interval. Alternatively heating can be applied by ultrasound irradiation, high frequency or radio frequency (RF) irradiation, or any combination of infrared and ultrasound irradiation. Alternatively, heating can be applied by jetting heated air at predefined quantities towards the layered plastic. Following any such heating cycle, the heated layered plastic is upheld still in place such that no harm involved with moving it might occur. At this stage, an embossing head replaces the heating member and its molding members are further forced to press the heated contour. In FIG. 9B a segment of embossing head 110 is schematically shown at an open position following the soldering of the edges of envelope 112. Shaped pressing faces such as pressing faces 114 extend from molding member 116 towards envelope 112 and recesses conformal to the fingers, not shown, are disposed on the side of member 118 facing the envelope, as described hereinabove. Pipes 120 respectively embedded in both molding members provide for conducting coolants thereby controlling the respective temperatures of the molding members at respective desired values. In such manner the soldering of the layered plastic that results in the embossed pattern is accomplished whilst the heated plastic cools off.

A soldering head of the first kind, in accordance with another preferred embodiment of the present invention, has a molding member that is made of relatively soft material. This molding member is produced according to a technique normally employed for producing a printing block or gravure, such as normally provided for color printing of plastic stickers. The gravure is made according to the present invention of silicone or of the same polymers such as those normally utilized in the industry of printing across plastic. The pressing faces of the gravure provide for forcing the layered sheets of plastic against a planar supporting surface across which a common electrical heater is placed. The separation distance between a plane that passes through the pressing faces and the background of the gravure exceeds the thickness of the layered sheets of plastic. Therefore, this surface cannot engage the surface of the layered sheets of plastic when the molding member is pressed against them. The heating member of this soldering head is positioned across the supporting surface which makes this surface to be a stiff supporting surface. The molding member, in addition to forcing the layered sheets of plastic towards each other, also provides for cooling them. The outline of the gravure can comply with any two dimensional geometrical shape as desired. Similarly, planar electric heaters formed in special geometrical shapes are commercially available. For example, in cases in which a relatively wide and elongated seam is desired, the geometrical shape of the gravure is rectangular and that of the electric heater is of a stripe, such as of stainless steel. Series of electrical pulses of a predefined number of pulses, time width and voltage provide for energizing the heater, the electrical resistance of which is given. Thereby, pulsed heating that is tunable is applied onto the layered sheets of plastic. The width in time of the pulses and the electrical voltage and power that energize the heater are suitably selected according to the method of the present invention in consideration with the heat capacities of the sandwiched plastic and of the heater, such that the heated plastic will be heated to the desired and predefined temperature. This temperature according to the method of the present invention is close to, and below, the melting point of the plastic considered. The pressing faces of this molding member have distinctive geometrical features such as the pressing faces described hereinabove. Such soldering head is especially suitable for configurationally heat soldering soft plastics such as polyethylene. This soldering head may be favorably compared to those having a molding member whose temperature is regulated to a fixed level, since the production of new gravure can be achieved at affordable costs and requires a relatively short time. Therefore, the replacement of a molding member can be conveniently accomplished and the production costs of packaging having seams of different graphical patterns become affordable.

The pattern embossed along the seam of envelope 112 includes distinct shaped bulges, such as bulges 122, conformal with the geometrical shape of the fingers of the male molding member. Recesses having similar distinct shapes are respectively disposed on the opposite face of the envelope.

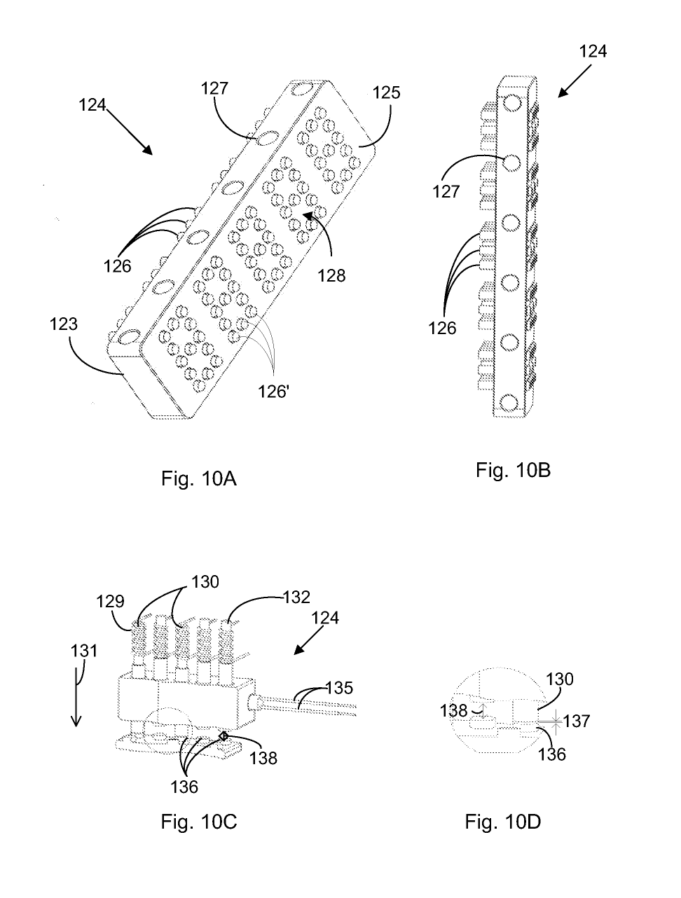

Reference is now made to FIGS. 10A-10B in which a molding member of a soldering head according to an embodiment of the present invention is respectively shown in two different views. Body 123 of molding member 124 has face 125. A plurality of fingers, such as fingers 126, are movably attached to body 123, such that one end of each finger protrudes off a respective aperture located on face 125. Pressing faces such as pressing faces 126′ point towards the layered sheets of plastic. The pressing faces are independently movable relative to face 125. Apertures such as aperture 127 provide for introducing electrical wires to power embedded heating elements, not shown. The fingers are grouped into a number of arrays such as array 128. The fingers of each array are arranged in columns and rows disposed along the sides of two squares having one common side. Such arrangement provides for forming alphanumerical characters by connecting respective pressing faces of selected fingers of an array, by linear segments as known. Array 128 is referred hereinafter as alphanumeric template.

In FIGS. 10C-10D, a segment of molding member 124 including only one column of fingers is shown in more detail. Solenoids, such as solenoid 129 that is mounted onto finger 130, provide for pulling it in the direction shown by arrow 131 when it is electrically powered. When the powering of solenoid 129 is turned off, a biasing spring, not shown, provides for pushing finger 130 back to its undisturbed state such as the state in which finger 132 is shown. Electrical wires 135 provide for simultaneously powering the heating elements of all the fingers of an array considered, such that all the pressing faces of these fingers are heated to the same predefined temperature. Each of bulges 136, positioned across from the supporting surface of the soldering head, are considered to face a respective pressing face of molding member 124, such that the layered sheets of plastic are sandwiched between the respective bulges of the supporting surface and the pressing faces of the respective fingers, which are electrically pulled along arrow 131. The uneven level of the supporting surface provides for releasing folds that accidentally appear across the layered sheets of plastic. Spacing 137 that separates between electrically pulled finger 130 and bulge 136 of the supporting surface is substantially smaller than the thickness of the layered plastic sheets considered. Therefore, segments of the sandwiched layered plastic, such as the segment pressed between heated finger 130 and bulge 136, are squeezed down while being pressed and heated up to the level in which they fuse. Such simultaneous heating and pressing is effected along a predefined time interval. By the end of this time interval, the electrically pulled fingers of a molding member are released to be sprung away off the layered plastic. The distance separating a finger at a normal stage (in which this finger is released) and its respective bulge that is represented by the double arrow 138 is significantly larger than the thickness of the layered sheets of plastic considered. Therefore, a heated contour across the plastic can cool down by delivering heat to the ambient atmosphere when it is released off the respective pressing face. The length of the above mentioned predefined time interval is selected in consideration with the heating power and the heat capacity of the sandwiched plastic.

A molding member of a heat soldering head according to a preferred embodiment of the present invention has a plurality of fingers arranged in two dimensional arrays, each of which has at least one row. Each finger is independently movable back and forth along the normal to the face of the molding member between two stages. In one stage, the pressing face of the movable finger is fully extended off the face of the molding member. In the other stage the finger is fully retracted such that its pressing face is pulled away from the surface of the layered sheets of plastic. The temperatures of all the pressing faces of the molding member are simultaneously regulated at a predefined temperature level.

Embodiment variants in accordance with the present invention are ones in which the fingers are securely attached to the molding member, such that all the pressing elements are fixed in place relative to the face of the molding member, but the temperatures of the pressing faces are independently regulated. Exemplary is a soldering member, the pressing faces of which are covered by electrical heaters, each of which is independently electrically powered.

For manufacturing a plastic packaging or bag according to the method of the present invention, any sheet or sheets of thermoplastic resins normally utilized in manufacturing common plastic bags can be utilized. For example, sheets made of high and/or low density polyethylene (HDPE, LDPE), as well as coextruded low/low, low/high and high/high density polyethylene (LLDPE, LHDPE, HHDPE), sheets made of polypropylene, PET and/or co-extruded sheets of any combination of the above mentioned materials, and/or plastic foam, bubbled sheets, sheets made of PVC and/or sheets made of nonwoven fabric such as Tyvek®, which is made of high density polyethylene fibers, can be utilized. Complex sheets of plastic that include foils of different plastic resins, such as the co-extruded sheets described above, are considered hereinafter as different sheets that are layered across from the other. Separated plastic sheets are first layered; then segments across the surface of the layered sheets of plastic are heated to a respective predefined temperature, which is below and close to the respective melting point of the plastic considered; the heated segments are pressed by a soldering head such as described hereinabove, and then cooled again to the ambient temperature. Heating and pressing can be either successively or concomitantly effected. In cases in which heating and pressing are concomitantly effected, heating is accomplished either by contact with a body the temperature of which is regulated to equal the desired temperature or by heat pulses, such as electrically generated, and further conducted through the pressing faces of the molding member into the layered plastic during the time interval along which the layered plastic is pressed. In order to avoid excessive heating to temperatures above the desired temperature level, the width in time of a heat pulse is predefined. The width in time of a heat pulse is selected in consideration with the heat capacity of the segment of the layered plastic and the heat capacity of the molding member, the length in time separating between two successive heating pulses, which depends on the rate of soldering, and the ambient temperature. Similarly, heating by infrared irradiation is effected along a predefined time interval along which the respective desired temperature of the targeted segments of the layered plastic is achieved to avoid full melting of the sheet at the heated zones. Optionally, the layered sheets are further pressed by means of a pressing member forced at a predefined level of forces prior to, and during, the time interval in which the heating member of a soldering head of the first kind presses them. Optionally, a foil coated with a heat-transferred color is sandwiched between some pressing faces and the topmost surface of the layered plastic facing them. The layered sheets to be mutually attached according to the invention are sandwiched between the jaws of an embossing head or between a soldering head of the first kind and a supporting surface. Preferably, the soldering head of the first kind presses the sandwiched layers of plastic against a cylinder, which is rotated along time intervals separating in between two successive soldering cycles. Cutting along the edges of the bags can be accomplished according to the invention either by means of a sharpened prism of a heating member of a soldering head concomitantly with soldering the edges of the bags, or independently by means of a cutting knife, as known. Configurational heat soldering plastic packaging of the present invention can be implemented in an automatic production line in which one folded, two (or more), elongated sheets of plastic are wound off two feeding drums and are stretched linearly between the jaws of an embossing head or between a soldering head of the first kind and a planar or a cylindrical supporting surface.

### Example 1

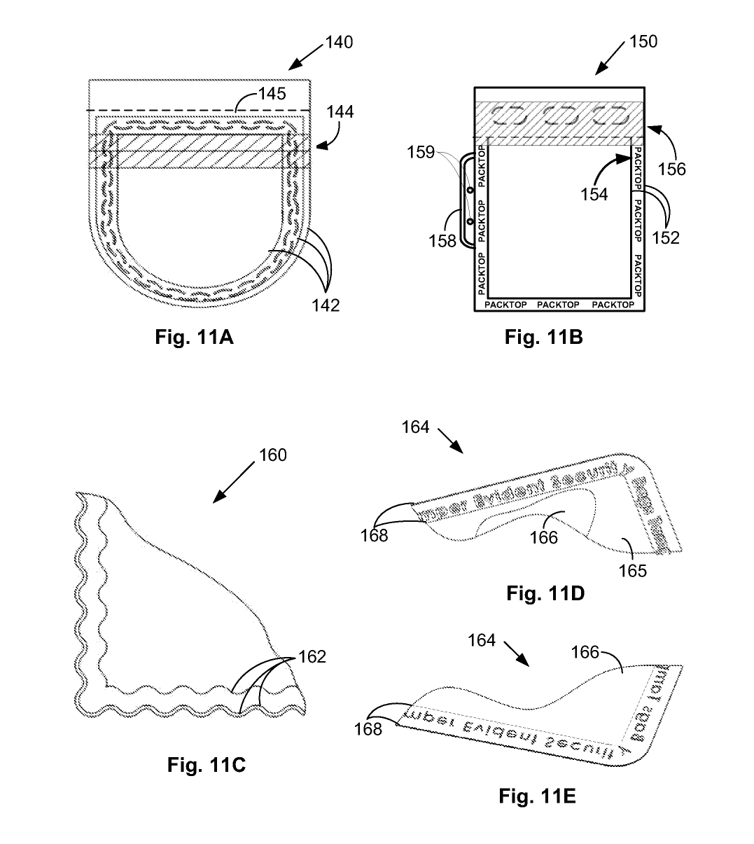

Reference is now made to FIG. 11A-11C, respectively showing three tamper evident envelopes according to three different preferred embodiments of the present invention. Tamper evident envelope 140, is made of two sheets of co-extruded polyethylene (HDPE+LDPE). These sheets are attached to each other by two continuous soldered seams 142. Seams 142 are generated by means of a soldering head of the first kind having inner and outer pressing faces shaped as, and/or arranged along, a curved line, such as a horseshoe, that extend outwards off the body of its heating member. The wiggles in-between seams 142 are generated by a plurality of curved and elongated pressing faces disposed between the continuous elongated and arcuate faces. Optionally, the seams and/or wiggles disposed between them are further colored by heat printing as described above. Optional perforated tear line 145 provides for the opening of tamper evident envelope 140. Otherwise, tamper evident sealing sticker 144 has to be first removed or cut for opening the envelope and getting access to its content, as known.

Tamper evident envelope 150 is made of bubbled sheet that is made of co-extruded polyethylene by means of a soldering head of the first kind. This soldering head is incorporated with a pressing unit such that the bubbles in the seam area are squeezed to give a good thermal contact between the various layers of plastic within the contour of the seam. Two continuous soldered seams 152 surround an embossed printed data 154 presented by means of imprinted alphanumerical characters. The continuous lines and the alphanumeric symbols are respectively generated with curvilinear pressing faces of prisms and shaped pressing faces of the respective fingers of the molding member. Tamper evident sticker 156 provides for sealing off the aperture of the envelope as known. The molding member employed is structured such that the outermost prisms are curved to include flap 158 as an integral part of the body of the envelope. Flap 158 provides for conveniently filing. Punched apertures 159 provide for filing envelope 150 such as within a dossier, can be either punched concomitantly with the configurational soldering or at a later stage by means of a common punch.

Wiggly and curvy seams, such as seams 162 of tamper evident envelope 160, with or without additional imprinted symbols and/or data in between, is another exemplary tamper evident envelope of the present invention. Envelopes having a single nonlinear and wiggly seam along their edges are in accordance with the present invention.

### Example 2

Envelopes of the present invention may have one face made of plastic sheet whereas the other face is made of a nonwoven fabric. Such envelopes are especially suitable for carrying paper money. In a soldering process, the heated plastic sheet fuses and some of it further gets into the spaces separating among various fibers of the nonwoven fabric onto which it is pressed while being heat soldered. Reference is now made to FIGS. 11D-11E, in which two opposing sides of a segment of tamper evident envelope 164 are respectively shown. Face 165 of envelope 164 is made of polyethylene. However face 166 is made of a nonwoven fabric such as Taft or Rayon. The seams along the edges shown in both figures include two continuous lines 168. A three dimensional pattern including alphanumerical characters is embossed in between lines 168. Such configurationally heat soldering is accomplished by means of embossing heads such as described hereinabove. Sheets of nonwoven fabric that are utilized for manufacturing envelopes of the invention in which one of their faces is made of polyethylene, for example, whereas the other face of the envelope is made of nonwoven fabric are also referred to hereinafter as plastic sheets

### Example 3

The inventor of the present invention has experimentally found that when a continuous region of a few millimeters square across layered sheets of a number of styles of Tyvek® are heated such that the material within the heated region fuses and is further cooled off for the purpose of heat soldering, the inner material within the soldered regions becomes transparent and brittle. Although a relatively thin soldered seam circumferential to the heated zone does exist, the inner region can be easily crumpled. However, the integrity of a discontinuous soldered seam across Tyvek® sheets, the area of the individual segments of which is within a range of 1-2.5 millimeters square, remains intact. Namely, a seam consisting of an array of soldered segments that are spaced apart; a seam that is shaped as a dashed or dotted line, retains almost the original integrity of a virgin Tyvek®. The minimal dimensions of the spaces separating two adjacent soldered segments are such that the material within a space does not change its color in comparison with the color of the virgin) sheet of Tyvek®. The maximal width of a soldered region as well as the minimal width separating two adjacent soldered segments can be experimentally found according to the invention by trial. However, as a rule of a thumb, the area of a soldered segment should not exceed about 2-2.5 mm² (two up to two and a half millimeters square), whereas the width of the spacing between two adjacent soldered segments may get down to half of the width of the soldered zone. Preferably, the margin of the heated regions are further pressed by means of a pressing member concomitantly while they are heated and further cooled off. In this manner an array of soldered segments is generated across the surface of the layered sheets of Tyvek®. By such limited heating to a predefined temperature that is lower than, however close to, the respective melting point, with or without pressing by means of a pressing member, for example a series of points, or along segments of a dashed line, in which the area of each segment or a point is within the range of 0.5-2.5 mm², a preferable area is 1 mm²; a soldered seam consisting of a series of fused regions, such as of point soldering, is generated.

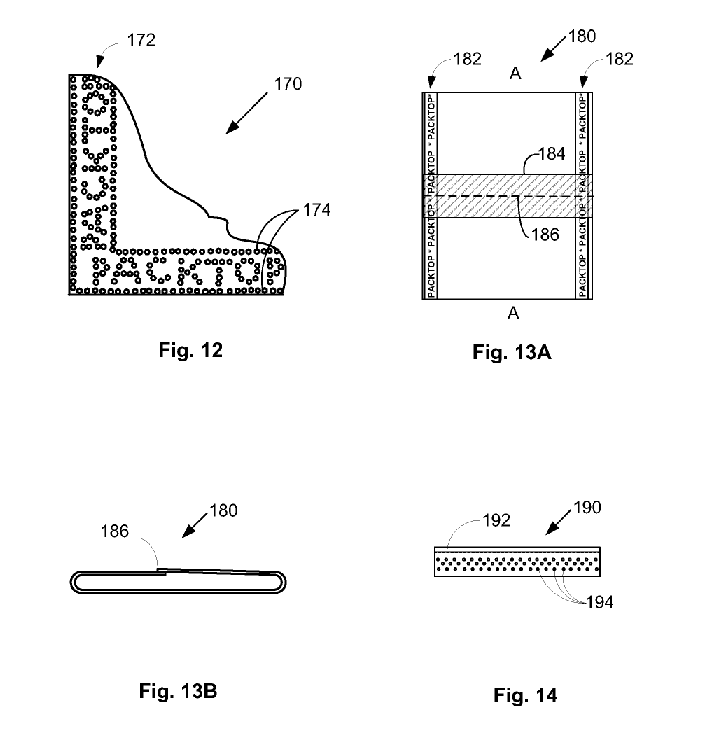

Reference is now made to FIG. 12 showing a tamper evident envelope according to a preferred embodiment of the present invention. Envelope 170 is made of two sheets of Tyvek®. The edges of envelope 170 are soldered by means of a soldering head of the first kind. A company name and/or logo or any text or graphical pattern is embossed across spacing 172 that is present between both linear seams 174. The spacing between adjacent soldered points as well as the multiple tiers of soldered points do not allow for introducing, for example, a fiber optic to search the content of the envelope.

An experiment to test the quality of configurationally heat soldered seams when the plastic sheets utilized are made of Tyvek® was carried out by means of soldering heads of the first kind without pressing members. The molding head of this soldering head includes a plurality of cylindrical fingers made of stainless steel. Temperature regulating circuitry provides for retaining the temperature of the pressing faces at a constant level (as specified in table 1 below). Circular pressing faces, the diameter of each of which is 1.8 millimeters (mm), are arranged in a two dimensional array having a given number of interleaved rows. Each pressing face is spaced apart from the adjacent pressing faces of the same row by 0.8 mm. Adjacent rows of the imprinted dots across the surface of the layered sheets of plastic are interleaved by respective linear displacements such that any direct line passing through a spacing that separates between two adjacent dots of the most externally located row (which is positioned by the external edge of the heat soldered seam) cannot reach any spacing disposed between two adjacent dots of the most inwardly located row without crossing at least one soldered dot. The table below lists the conditions in which such configurational heat soldering was accomplished in the reported experiment. All the styles of Tyvek® that were heat soldered according to the method of the present invention are specified by the manufacturer of the Tyvek® as not being capable of being heat soldered in accordance with common heat soldering techniques.

TABLE 1
Working parameters considering exemplary tamper evident
envelopes made of two sheets of Tyvek^{(R)} of various styles.

| Tyvek^{(R)} style | 1056D | 1056D | 1082D | 1073D |
|---|---|---|---|---|
| foil thickness (micrometers) | 124 | 126 | 254 | 190 |
| range of heating temperatures | 175-185 | 175-185 | 175-185 | 175-185 |
| (degree Celsius) | | | | |
| heating time (seconds) | 1-1.5 | 1-1.5 | 1-1.5 | 1-1.5 |

### Example 4

The manufacturing time of tamper evident envelopes depends on the number of open edges per one envelope along which seams have to be heat soldered. By utilizing a folded plastic sheet one can fabricate envelopes having two open sides that have to be sealed by heat soldering. The third open side can be used as the aperture of the envelope that can be sealed off by the user by means of a tamper evident sticker as known. Reference is now made to FIGS. 13A-13B. In FIG. 13A side looking view of tamper evident envelope 180 is shown. Two seams 182, each of which includes a three dimensional embossed logo disposed in between two continuous lines, such as the seam shown in FIGS. 11D-11E. Tamper evident sticker 184 seals the aperture of the envelope. Broken line 186 designates the end of the top flap of the cover of the aperture of the envelope. FIG. 13B is a sectional view along line AA of the envelope shown in FIG. 13A. An exemplary inexpensive soldering head of the present invention includes a male molding member, such as molding member 190, a side looking view of which is shown in FIG. 14 to which reference is now made. Linear prism 192 and a two dimensional array of sharpened and relatively elongated pins, such as pins 194, extend off the face of molding member 190. A matching female mold, not shown, includes an elongated groove conforming to the prism and an array of recesses that respectively conform to the elongated pins. The pins provide for perforating the tamper evident envelope such that a relatively thin circular seam is disposed circumferential to any of the punched holes made by any of the elongated pins 194. Another soldering head according to an embodiment of the present invention has a male molding member that includes only a row, or a two dimensional array, of pins extending off the face of the male molding member, all of which have the same predefined temperature. A female mold includes the respective recesses that conform to the pins. Such a soldering head can be employed for producing a seam that includes an array of holes, the margins of which are heat soldered. Optionally, such a soldering head can be added as an additional soldering station to a production line of tamper evident envelopes that include a common soldering station providing for soldering linear seams as known.

1. A method for configurationally heat soldering a seam along which at least two segments of sheets of layered sheets of plastic are mutually attached, wherein at least one selected region disposed across the external surface of said layered sheets of plastic is heated to a predefined temperature by means of a heating member, said method comprising forcing a molding member against said layered sheets of plastic along a predefined time interval, which is the first time interval, wherein said molding member comprises a plurality of pressing faces extending from the side of said molding member facing said layered sheets of plastic, and wherein each of said plurality of pressing faces has a distinctive geometrical shape, and wherein the footprint of at least one of said plurality of pressing faces across said layered sheets of plastic is positioned within said at least one selected region, and wherein said predefined temperature is close to the melting point of at least one of said layered sheets of plastic, and wherein said predefined temperature is lower compared to said melting point.

2. A method as in claim 1, wherein said layered sheets of plastic are compressed between said molding member and a supporting surface positioned at the side of said layered sheets of plastic opposing the side facing said molding member.

3. A method as in claim 2, wherein said supporting surface is cylindrical and rotatable.

4. A method as in claim 1, wherein said heating is concomitantly effected with said forcing.

5. A method as in claim 4, further comprising pressing said layered sheets of plastic by means of at least one bulge protruding off a pressing member, wherein said pressing is exerted onto said layered sheets of plastic at the margin of at least one of said footprints.

6. A method as in claim 5, wherein said heating is effected along said first time interval.

7. A method as in claim 6, further comprising continuously pressing said layered sheets of plastic at said margin of at least one of said footprints, wherein said continuously pressing starts prior to the beginning of said first time interval and further continues along a second time interval immediately following the end of said first time interval.

8. A method as in claim 1, wherein said predefined temperature is the first temperature and the side of said layered plastic facing the molding member is the first side, and wherein a mold, the temperature of which is a second temperature, which is different from said first temperature, is forced against said layered sheets of plastic across the side opposing said first side, and wherein forcing by said mold is concomitantly effected with said forcing by the molding member, and wherein said mold comprises at least one recess accommodated to enclose at least one of said plurality of pressing faces.

9. A method as in claim 8, wherein said second temperature is lower compared to said first temperature by a predefined temperature difference.

10. A method as in claim 8, wherein said second temperature equals said first temperature.

11. A method as in claim 1, wherein said molding member comprises a heating member.

12. A method as in claim 2, wherein a heating member is positioned across said supporting surface.

13. A method as in claim 1, wherein at least one of said layered sheets of plastic is a nonwoven fabric.

14. A heat soldering head for imprinting a pattern along a seam located across a surface of layered sheets of plastic, wherein targeted regions across said surface are heated, said heat soldering head comprising a molding member, wherein said molding member comprises a plurality of pressing faces extending off one side of said molding member, for pressing against said surface, and wherein at least one of said plurality of pressing faces has a distinctive geometrical shape.

15. A heat soldering head as in claim 14, further comprising a pressing member for pressing against said surface at the periphery of the footprint of said at least one of said plurality of pressing faces across said surface.

16. A heat soldering head as in claim 14, wherein the temperature of said at least one of said pressing faces is controllable.

17. A heat soldering head as in claim 14, wherein said distinctive geometrical shape is selected from a group of geometrical shapes consisting of broken line, dashed line, dotted line, curvilinear line, wiggled line, geometrical closed shapes, typographical features, graphical symbols, alphanumerical characters, and any combination thereof.

18. A heat soldering head as in claim 14, wherein an electric heater is attached to said at least one of said plurality of pressing faces.

19. A heat soldering head as in claim 14, wherein one of said plurality of pressing faces is movably attached to said molding member, and wherein the position of said at least one of said plurality of pressing faces relative to said side of said molding member is changeable between two stages, in one of which, which is the first stage, said at least one of said plurality of pressing faces is positioned at a first distance away from said side of said molding member, and wherein in the other stage said at least one of said plurality of pressing faces is positioned at a second distance away from said side of said molding member, and wherein said second distance is larger compared to the first distance.

20. A heat soldering head as in claim 14, further comprising a mold, wherein said mold comprises a plurality of recesses, at least one of which is accommodated to enclose said at least one of said plurality of pressing faces, and wherein the temperature of said mold is controllable.

21. A heat soldering head as in claim 14, wherein said layered sheets of plastic are positioned across a supporting surface,

22. A tamper evident packaging made of layered sheets of plastic wherein respective segments of at least two sheets of said layered sheets of plastic are laid one across the other, and wherein said respective segments are heat soldered one to the other along a seam having two faces, each of which is positioned across the surface of the respective segment of said at least two sheets, said tamper evident packaging comprising at least one distinctive pattern embossed across a surface of at least one of said segments of sheets, and wherein said pattern comprises at least one feature having a distinctive three dimensional geometrical shape.

23. A tamper evident packaging as in claim 22, wherein said geometrical shape is selected from a group of geometrical shapes including broken line, dashed line dotted line, curvilinear line, wiggled line, geometrical closed shapes, graphical features, graphical symbols, alphanumerical characters, and any combination thereof.

24. A tamper evident packaging as in claim 22, wherein said three dimensional geometrical shape comprises a bulge protruding off one face of said seam and a recess that conforms to said bulge disposed across the other face of said seam.
